(19) United States
(12) Patent Application Publication
(10) Pub. No.: US 2026/0326055 A1
(43) Pub. Date: Oct. 22, 2026

(54) MOBILE SLURRY SYSTEM

(71) Applicant: Mississippi Lime Company, St. Louis, MO (US)

(72) Inventors: Nathan Hooper, Farmington, MO (US); Elizabeth Jackson, Crystal City, MO (US); Todd Kester, Millersville, MO (US)

(21) Appl. No.: 19/638,768

(22) Filed: Apr. 3, 2026

Related U.S. Application Data
(60) Provisional application No. 63/782,709, filed on Apr. 3, 2025.

(51) Int. Cl. B01F 33/502; B01F 23/50; B01F 23/53; B01F 35/10; B01F 35/11; B01F 35/221; B01F 35/222; B01F 35/88; B01F 101/28; C04B 28/10

(52) U.S. Cl. CPC B01F 33/5023; B01F 23/511; B01F 23/53; B01F 23/565; B01F 35/11; B01F 35/1452; B01F 35/2211; B01F 35/222; B01F 35/883; C04B 28/10; B01F 2101/28

(57) ABSTRACT

A mobile slurry system specifically designed to form lime slurries and specifically lime hydrate slurries. The system utilizes an automated controller to provide for accurate initial composition formation as well as to provide for maintenance of formed slurries over time. Embodiments of the system also include internal pressure control to best handle pneumatic conveying. Finally, embodiments of the system include a specific washing apparatus to avoid material caking on the inside of the vessel. These systems can utilize the wash water as part of a future slurry production to increase concentration accuracy.

### CROSS REFERENCE TO RELATED APPLICATION(S)

This application claims the benefit of U.S. Provisional Patent Application Ser. No. 63/782,709 filed Apr. 3, 2025, the entire disclosure of which is herein incorporated by reference.

### BACKGROUND OF THE INVENTION

### Field of the Invention

This disclosure relates to a mobile system or station that can be used to generate slurries from particulate matter on-site. The system can then store and automatically maintain the slurry over time using automated maintenance procedures, and can automatically clean the tank after slurry discharge in a manner that preserves unused particulate matter and maintains the system in working order.

### Description of the Related Art

Calcium carbonate (CaCO3), more commonly known as lime or limestone, is a naturally occurring substance having a number of industrially useful applications. Lime can be used as a source material to produce calcium oxide (CaO), also sometimes called “quicklime,” by calcining it in a kiln. Quicklime also has many industrial uses, and can further be “slaked” (combined with water) to form calcium hydroxide (Ca(OH)2), also sometimes called “lime hydrate.” Lime hydrate in this initial slaked form is commonly called “slaked lime.” There is also a calcium hydroxide compound commonly known as “hydrated lime” which is commonly produced by removing the water from slaked lime and drying the lime hydrate.

There are many applications for lime hydrate including in the treatment of surface or well water in potable water treatment plants and to treat industrial wastewater and decant water in sludge plants. In applications where the lime hydrate will be used in a water application, lime hydrate is typically introduced into the process in a wetted form, such as a slurry, a paste, or as lime milk or limewater. All of these forms are essentially just suspensions of the lime hydrate in water with the relative concentration changing between them. Lime milk or lime water is effectively a low concentration suspension, a slurry is a higher concentration, and a paste being higher still. In practice, all these forms are sometimes referred to as lime slurries. Wetted forms are typically preferred to dry powder because using the lime in a dry form usually creates dust problems that have to be overcome. There are generally two forms of lime hydrate which are provided in such wetted forms.

One such wetted form, regardless of water content, is referred to herein as a “slaked lime slurry.” A slaked lime slurry is a lime slurry which has been formed from slaked lime and, essentially, never dried (although some water may have been removed or liberated as steam in the slaking process). A “hydrated lime slurry,” on the other hand, refers to a slurry which has been made from a previously formed and dried lime hydrate (e.g., hydrated lime) that is then reintroduced to water to form a slurry or other wetted form. It should be recognized that the two forms should be expected to be chemically similar and perhaps identical. However, some debate exists about the efficiency of using slaked lime slurry or hydrated lime slurry in certain applications.

Hydrated lime slurries have been disfavored by some because it is thought that they have a larger particle size than slaked lime slurries (due to the drying and rewetting process), and, therefore, are less reactive. It is thought that slaked lime slurries contain smaller, more reactive lime hydrate particles than a hydrated lime slurry made by mixing water and hydrated lime because the lime hydrate particles agglomerate in the hydrated lime slurry, thereby producing a slurry containing lime hydrate particles having less effective surface area than in a slaked lime slurry. Thus, slaked lime slurries are preferred for certain applications. At the same time, in other applications hydrated lime slurries are preferred due to their ease of production, and often more importantly, their ease of transportation.

Users of either type of lime slurries have been faced with a difficult decision on how to form the slurry. Typically, those wishing to use a slaked lime slurry either have had to slake their own calcium oxide on site to produce the slaked lime slurry (which can be a technically demanding activity), or buy slaked lime already in slurry form. Those using hydrated lime slurries, however, can purchase the lime already in slurry form, but can more typically simply purchase prepared hydrated lime in a powder form and then form it into a slurry on premises.

It should be apparent that transporting a slurry is undesirable compared to transporting a powder to form into a slurry on site. Because of the high water content of the slurry (often 60% to 98% by weight of common lime slurries), transportation of a slurry adds substantial weight, which significantly increases shipping costs compared to transporting hydrated lime in a dry powder form, and supplying your own water and vessel to form the slurry.

Water is widely available and typically much cheaper to acquire locally or through a prepared infrastructure than ship overland. This is particularly true where the slurry is intended for use in water treatment as, by definition, a water treatment plant will have ready access to water. By preparing the lime slurry onsite where it is intended to be used, one eliminates the need to pay shipping costs for water. The downside of preparing the slurry onsite is needing to store it or prepare it on demand. Preparing a hydrated lime slurry is typically not complicated, but does require infrastructure and control.

To form a slurry on-site, dry hydrated lime is purchased and reconstituted from a powder by mixing the powder with water in a fixed ratio. Lime slurry formation typically does not require management of many process variables as the only real variable is the ratio of solids to water. However, on-site slurry formation and use does best with consistent and regular mixing. In order to minimize transportation costs, it is desirable to purchase larger amounts of hydrated lime powder at a time. Further, as this is often delivered by truck and in bulk form, it is necessary to take possession of the entire truckload at a single time. This requires storage and the ability to form the slurry in the amounts and concentrations needed by the process from the entire shipment at once. Further, slurries also typically require some ongoing maintenance when stored to avoid the slurry separating. Hydrated lime powder is also often quite fine compared to other particulates which can present material handling difficulties.

In some operations, the hydrated lime is stored in a powder form on-site and is then reconstituted on-site in what is essentially an on-demand batch or even continuous process. To do this, the site needs to have a storage vessel for the powdered lime and a mixing vessel. The mixing vessel is typically substantially smaller and will produce the slurry on-demand in relatively small batches (or essentially continuously depending on the processes used) compared to the on-site powdered lime reserve. While this can be very efficient, it does require that the site have both a storage and a mixing vessel, that the mixing vessel be sized and operated correctly to meet the ongoing needs of the operation, and that on-site storage be present for the hydrated lime powder.

Further, hydrated lime powder is typically quite fine meaning that conveying infrastructure for it is usually much more complex to handle and convey than it is for handling liquids and slurries. Owning a mixing vessel also requires appropriate maintenance plans and upkeep of the vessel and such vessel operation is typically not automated. Further, in some cases, the site may need relatively large batches of slurry at once meaning that the entire stored amount of powder could be used in a single batch. In this case, the onsite storage plus large mixer rapidly becomes less cost effective as the user may be paying for substantial mostly unused capacity.

To deal with the problems of on-site generation of slurries in a variety of industries, there are a family of mobile slurry making machines or stations which are designed to provide for slurry production on demand and which can typically handle large throughput and storage. Many of these are not built for calcium hydroxide slurries, however, but are made for on-site creation of materials such as concrete. In these machines, the contents of an entire truckload of powder is designed to be fed into the machine and combined with water from a local water source. The slurry can then be kept in the mobile machine for a period of time and used as needed. As the systems are mobile, they can be stored at a temporary jobsite and can be used in emergencies when an on-site system breaks down.

While effective, these mobile systems suffer from a number of drawbacks with regards to calcium hydroxide slurry formation. The primary problem is that they are not built for making lime slurries but for slurries utilizing larger solid particulates that may not require pneumatic conveyance. Lime slurries are typically made with extremely fine powders and the mixing vessel is often not completely full of water. This can result in lime dust getting into the headspace of the vessel and not being mixed into the slurry compared to traditional slurry such as concrete where the solid particulates are not readily suspended in air due to their larger size.

Over time, lime hydrate dust in the headspace of a mobile slurry machine, or which settles from the slurry onto tank walls, can also buildup on the inside of the vessel if it is not regularly cleaned. Another major issue is that the fine lime powder is typically conveyed pneumatically as opposed to with a gravity feed which is more common with other materials having larger particulate size and mass. During fill, pneumatic feed systems typically increase pressure inside the vessel while gravity feed systems do not which can present a danger if the system is not built to handle the pressure change. Further, when slurry is removed, it can also result in vacuum inside the vessel and that also must be dealt with. A final issue is that lime slurries, unless rapidly used after being formed, will separate over time. This can lead to buildup of deposits but also to slurries of inaccurate concentration being dispensed if the slurry is stored for a decent amount of time.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a mobile slurry system specifically designed to form lime slurries and specifically lime hydrate slurries. The system utilizes an automated controller to provide for accurate initial composition formation as well as to provide for maintenance of formed slurries over time. Embodiments of the system also include internal pressure control to best handle pneumatic conveying. Finally, embodiments of the system include a specific washing apparatus to avoid material caking on the inside of the vessel. These systems can utilize the wash water as part of a future slurry production to increase concentration accuracy.

There is described herein, among other things, a mobile slurry forming system, the system comprising: a trailer, having wheels and with a tank mounted thereon, said tank including an internal mixer and a motor for operating said internal mixer; a controller; a valve for equalizing pressure in said tank compared to the ambient; a dust collector; a water inlet for supplying water to said tank; a product inlet, for receiving a particulate from a pneumatic conveyor; a discharge line, for discharging contents of said tank; and a spray head, for spraying inner walls of said tank; wherein, said controller calculates an amount of added water to add to said tank based on an amount of particulate to be provided to said tank, a desired slurry concentration, and an amount of slurry already present in said tank; wherein, said amount of added water is supplied to said tank via said water inlet and said spray head, in combination; wherein, said amount of particulate is provided to said tank via said product inlet; and wherein, said controller activates said motor to engage said mixer to form a slurry in said tank.

In an embodiment of the system, at least a portion of said added water is provided to said tank prior to said particulate being provided to said tank and said particulate and air from said pneumatic conveyor is injected into said tank within said portion of said added water.

In an embodiment of the system, the dust collector removes suspended particulate from a headspace in said tank.

In an embodiment of the system, the valve releases extra pressure generated in said tank from said pneumatic conveyor.

In an embodiment of the system, the tank can move relative to said wheels.

In an embodiment of the system, the controller initiates a wash cycle where said controller activates said spray head when said water inlet is not being used to supply water to said tank and said product inlet is not supplying particulate to said tank.

In an embodiment of the system, the controller records an amount of wash water added to said tank during said wash cycle.

In an embodiment of the system, the wash water adds particulate suspended on said inner walls to said slurry.

In an embodiment of the system, the controller initiates a maintenance cycle where said controller activates said motor to turn said mixer when said water inlet is not being used to supply water to said tank and said product inlet is not supplying particulate to said tank.

In an embodiment of the system, the particulate comprises calcium hydroxide.

There is also described herein, in an embodiment, a method of forming a slurry, the method comprising: providing a mobile slurry system, the system comprising: a trailer, having wheels and with a tank mounted thereon, said tank including an internal mixer and a motor for operating said internal mixer; a dust collector; and a spray head, for spraying inner walls of said tank; calculating an amount of added water to add to said tank based on an amount of particulate to be provided to said tank, a desired slurry concentration, and an amount of slurry already present in said tank; supplying said added water to said tank at partially through said spray head; supplying said amount of particulate to said tank; and activating said motor to engage said mixer to form a slurry in said tank.

In an embodiment of the method, at least a portion of said added water is provided to said tank prior to said particulate being provided to said tank and said particulate is injected into said tank within said portion of said added water.

In an embodiment of the method, the dust collector removes suspended particulate from a headspace in said tank.

In an embodiment, the method further comprises: releasing extra pressure generated in said tank from said amount of particulate being supplied.

In an embodiment, the method further comprises: moving said tank relative to said wheels before said tank is supplied with said added water.

In an embodiment, the method further comprises: washing said tank by activating said spray head when said water inlet is not being used to supply water to said tank and said product inlet is not supplying particulate to said tank.

In an embodiment, the method further comprises: recording an amount of wash water added to said tank during said washing.

In an embodiment of the method, the wash water adds particulate suspended on said inner walls to said slurry.

In an embodiment, the method further comprises: maintaining said slurry by activating said motor to turn said mixer when said water inlet is not being used to supply water to said tank and said product inlet is not supplying particulate to said tank.

In an embodiment of the method, the particulate comprises calcium hydroxide.

### BRIEF DESCRIPTION OF THE DRAWINGS

FIG. 1 provides a rear perspective view of an embodiment of a mobile slurry system in a trailer configuration for slurry production as opposed to active transport.

FIG. 2 provides a simplified cut-through view of another embodiment of a mobile slurry system showing internal structure.

### DETAILED DESCRIPTION OF PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

This disclosure will regularly refer to a lime hydrate slurry. It should be recognized that the term “slurry” is typically intended to cover a suspension having a relatively high variability in solids concentration. However, the term is intended to be even broader in the present application than it is often used in the art and is used interchangeably herein to refer to slurries, pastes that can be mechanically moved, as well as lime waters, lime milks, and other suspensions of particularly low solids concentration. In effect, a “slurry” as used herein, is any purposeful suspension of a particulate in water in any concentration.

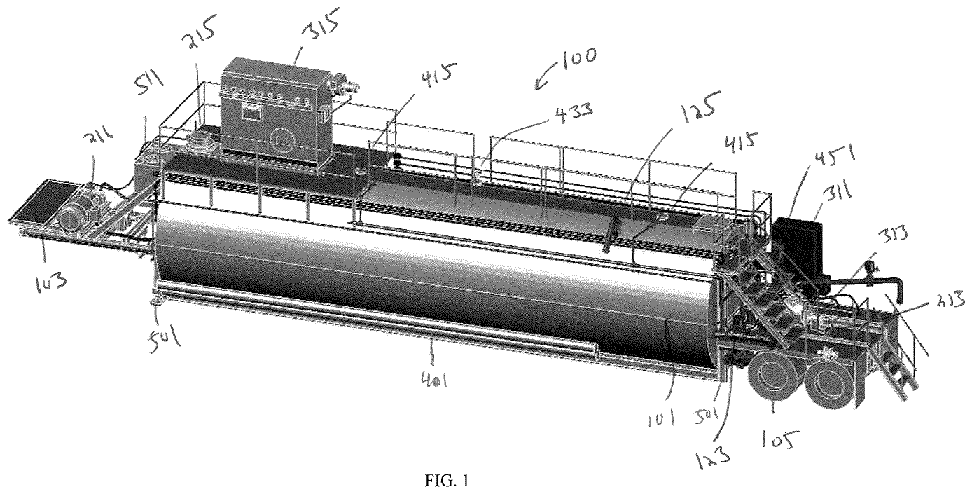

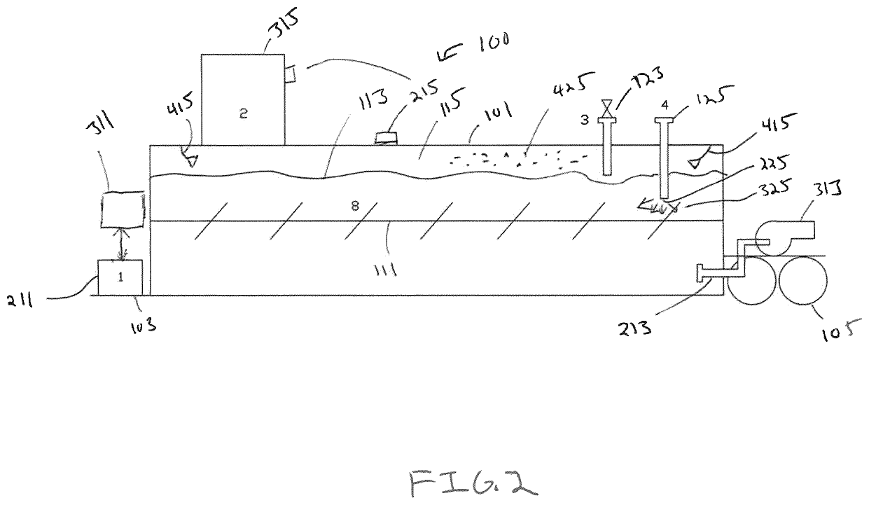

FIG. 1 provides for an embodiment of a mobile slurry system (100) or station. FIG. 2 shows a simplified cut-through drawing of another embodiment of a mobile slurry system (100) so to allow visualization of internal structure. The two depicted systems (100) are generally of similar construction and contain similar components. However, the specific positioning of the components can change. This movement of components within the system (100) may be due to design choices or due to specific needs based on the size of the tank (101).

The systems (100) generally comprise a tank (101) which is generally arranged so as to have its longest dimension horizontal as opposed to vertical. The tank (101) will typically be mounted as part of a towable trailer so will include a hitch (103) and wheels (105). In an alternative embodiment, the hitch (103) may be eliminated and the system (100) may be made self-propelled. In a still further embodiment, the system (100) may include more wheels (105) so as to be capable of free-rolling.

The tank (101) may be designed to be moveable relative to the rest of the towable trailer structure and specifically the wheels (105). Specifically, the tank (101) may be mounted on a center bed (401) which can be raised and lowered relative to the wheels (105) and/or hitch (103). Specifically, as can be seen in FIG. 1, the tank (101) may be lowered when the system (100) is making or storing slurry. Specifically, the tank (101) may be lowered so that the center bed (401) is resting on the ground. As the tank (101) will be substantially heavier when full of slurry than it will be when empty, positioning the center bed (401) on the ground eliminates stress on the center bed (401) and/or wheels (105) as they are not forced to support the tank (101) when it is full of slurry. However, to move the system (100) to a new location, the center bed (401) and tank (101) can be raised to a higher position (typically about level with the platform above the wheels (105)) when the system (100) is to be transported. This higher position provides sufficient clearance between the center bed (401) and the ground to allow safe transport of the system (100), typically by being pulled behind a typical tractor in a typical tractor-trailer arrangement.

The raising and lowering of the center bed (401) (and tank (101)) can be accomplished through the use of legs (501) which can be lowered to the ground and then used to lower the center bed (401) to the ground. The process can then be reversed to raise the center bed (401) and once the center bed (401) is raised, the legs (501) may also be raised. The legs (501) may utilize any technology, automated or manual, to be raised and lowered but will typically utilize hydraulic pressure. To do so, the system (100) may include a hydraulic tank (511), hydraulic pumps, and associated hydraulic systems.

As can be seen in FIG. 2, internal to the tank (101) is a mixing blade or mixer (111). The mixer (111) will typically be in the form of a screw or auger mixer running horizontally, but that is by no means required and other forms of mixer (111) may be used. The horizontal arrangement of mixer (111) will typically be preferred because the tank (101) will be provided with water (113) to a level which is below the top of the tank (101) but will generally be above at least a portion of the mixer (111).

The mixer (111) will typically be held in place in the tank (101) by a seal that allows it to rotate, while still inhibiting the flow of slurry through the connection point of the mixer (111) and tank (101). This may be accomplished by any mechanism, but in the depicted embodiment of FIG. 1 is accomplished through the use of a packing gland. The reader should recognize that the addition of the calcium hydroxide increases the total volume of material in the tank (101) by the volume of the calcium hydroxide so the tank (101) typically cannot be completely full of water (113) before the powder (325) is added. The water (113) is supplied via a metered water valve (123) which supplies the water (113) from an external source.

Powdered calcium hydroxide (325) is supplied via a product inlet (125). The powder (325) will typically be pneumatically conveyed and will be supplied from a source which will typically be a transportation vehicle such as a tractor-trailer of the type known for transporting powders (325) and having its own systems for discharge via pneumatic conveyance. The inlet (125) will generally be arranged so that the discharge end (225) of the inlet (125) is below the water level (113) for the generation of most common slurries. In this way, the powder (325) is effectively injected into the water (113). This can increase the dispersion of the powder (325) within the water (113) as the air being used to move the powder through the inlet (125) will agitate the water (113) as it is released due to bubbles formed from such placement. It will also inhibit the powder (325) from entering the headspace (113) upon the powder's (325) initial arrival in the tank (101).

As the powder (325) is conveyed into the inlet (125) and dispersed by the bubbles, however, some of the powder (325) will be carried by the bubbles and ejected into the headspace (115) either as powder, as a wetted powder, or as part of a slurry depending on the specific physics involved. Ejected powder (325), whether wetted or not, may comprise sufficiently small particles that some will remain suspended in the headspace (115) after ejection. Even powder (325) which is suspended in the water (113) which is ejected by the bubbles may remain in the headspace either because the water evaporates or because the water (113) may splash on the walls of the tank (101) in the headspace (115) and the powder (325) is left as a residue after the water separates. Regardless of the particular mechanism, some of the powder (325) may become suspended in air in the headspace (115) or on the walls of the headspace (115). Further, the input of air as part of the pneumatic conveyance of powder (325) through the inlet (125) will typically increase the pressure in the headspace (115).

To deal with the increase in pressure, a valve (215), which is typically a P/V valve will be provided in the tank (101). This will serve to reduce the pressure to avoid the tank (101) becoming pressurized from the volume of gas and powder (325) supplied thereto. While a decrease in the pressure may cause the powder (325) trapped in the headspace (115) to simply fall into the water (113), some powder (425) will likely remain suspended in the headspace (115) even with a pressure change.

This suspended powder (425) presents a couple of concerns. In the first instance, the suspended powder (425) is of unknown amount and is acting to reduce the concentration of calcium hydroxide in the resultant slurry (as it is not suspended in the water (113)). If the slurry is not used quickly, but is allowed to sit for substantial time, this will be reduced, but that situation may not be present or possible. In the second instance, the suspended powder (425) can settle on the inside of the tank (101) surface in the headspace (115) which can result in build-up over time in the tank (101) which can be problematic. Some of the suspended powder (425) will likely enter the water (113) simply because the water (113) level may be rising as the slurry is formed and the volume of the slurry increases.

To assist in removal of the suspended powder (425) from the headspace (115), the system (315) will generally include a dust collector (315). The dust collector (315) will be of typical design and may use a variety of different technologies. In most cases, the purpose of the dust collector is simply to capture the suspended powder (425) and then allow the captured powder (425) to simply drop into the water (113) or to be injected into the water and be integrated into the slurry. This is generally effective to dramatically reduce the amount of suspended powder (425) and avoid concerns as to the reduction of the amount of calcium hydroxide suspended in the water (113) being significant due to the suspended powder (425). However, it will still not completely eliminate the suspended powder (425) in certain embodiments.

In order to form a slurry from the calcium powder (325) and the water (113), the mixer (111) will typically be driven by a motor (211). The motor (211) will generally be an electric motor and will be controlled by a controller (311). However, there is no requirement that the motor (211) be electric and internal combustion, diesel, and other motors may be used in alternative embodiments. The controller (311) will typically be some form of digital processor or computer collocated with the system (100) and including storage media for running appropriate software to carry out the indicated functions, but that is by no means required. The controller (311) may also be hard engineered via dedicated circuitry. In other alternative embodiments such software may be placed on a mobile communication device or other device which is in communication with the motor (211) and other components of the system (100) such as through a network. In this way, the motor (211) and other components may be controlled and/or monitored remotely from the system (100). Combinations of the above options may also be used. Regardless of the design and positioning of the controller (311), the controller (311) will typically act to control all the process operations of the system (100) in real-time as discussed in more detail later.

Power to the system may be provided by known methodologies. If a fossil fuel-based motor (211) is used, an alternator and electrical distribution system may be used to generate and distribute electricity from the motor (211). If the system (100) is entirely electric, the system may be supplied from a grid or other external power connection. Alternatively, or additionally, the electricity may be provided by on-board electric and/or other power generation systems including, but not limited to, combustion systems, solar panels, kinetic capture methodologies such as windmills, or small scale nuclear reactors.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including, but not limited to eyewear, wrist wear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, may refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices that are not conventionally thought of as “computers” nevertheless exhibit the characteristics of a “computer” in certain contexts. Where such a device is performing the functions of a “computer” as described herein, the term “computer” includes such devices to that extent.

Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device”. A mobile communication device may be, but is not limited to, a smart phone, tablet PC, e-reader, satellite navigation system (“SatNav”), fitness device (e.g., a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a traveler's person, and usually is in constant communication with a network.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software may be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer-or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the term “network” generally refers to a voice, data, or other telecommunications or similar network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network. Servers and clients may also exist virtually in so-called “cloud” arrangements.

Throughout this disclosure, the term “real-time” generally refers to software performance and/or response time within operational deadlines that are effectively generally cotemporaneous with a reference event in the ordinary user perception of the passage of time for a particular operational context. Those of ordinary skill in the art understand that “real-time” does not necessarily mean a system performs or responds immediately or instantaneously. For example, those having ordinary skill in the art understand that, where the operational context is a graphical user interface, “real-time” normally implies a response time of about one second of actual time for at least some manner of response from the system, with milliseconds or microseconds being preferable. However, those having ordinary skill in the art also understand that, under other operational contexts, a system operating in “real-time” may exhibit delays longer than one second, such as where network operations are involved which may include multiple devices and/or additional processing on a particular device or between devices, or multiple point-to-point round-trips for data exchange among devices. Those of ordinary skill in the art will further understand the distinction between “real-time” performance by a computer system as compared to “real-time” performance by a human or plurality of humans. Performance of certain methods or functions in real-time may be impossible for a human, but possible for a computer. Even where a human or plurality of humans could eventually produce the same or similar output as a computerized system, the amount of time required would render the output worthless or irrelevant because the time required is longer than how long a consumer of the output would wait for the output, or because the number and/or complexity of the calculations, the commercial value of the output would be exceeded by the cost of producing it.

Once the powder (325) has been completely supplied to the tank (101) from its initial source, a slurry will have been made. However, the slurry may not, with sufficient certainty, be sufficiently uniform to be suitable for its intended use. The mixer (111) will typically be instructed by the controller (311) to mix for a predetermined period of time after all the powder (325) has been supplied to provide increased likelihood of more even distribution of the powder (325) in the water (113). Once this is completed, the controller (311) will typically shut off the motor (211) and the mixer (111) and the slurry may be maintained in the tank (101) until needed.

Depending on the intended use of the slurry, how the slurry is dispensed from the system (100) may change. In an embodiment, the slurry is used in small batches with unused slurry being stored in the tank (101) while in an alternative embodiment the slurry will be dispensed from the tank (101) all at once. Regardless of which way the slurry is dispensed, the slurry will typically be dispensed via the drain (213) by action of a pump (313) which is also typically controlled by the controller (311). As the pump (313) is removing the slurry, the headspace (115) will typically reduce in pressure which can cause a vacuum in the headspace (115). To avoid this, the P/V valve (215) will typically allow atmospheric air to enter the headspace (115) to avoid a vacuum being generated and maintain pressure at around an expected equilibrium.

If the slurry is not needed all at once, the controller (311) will typically maintain a slurry maintenance cycle to provide for maintenance of the quality and concentration of the slurry. In such a cycle, the controller (311) will automatically engage the motor (211) according to a maintenance cycle (which may be at regular intervals) to turn the mixer (111) and agitate the slurry. This will typically inhibit the particles (325) from precipitating out of the slurry.

Regular slurry mixing such as this has always been recommended for slurry maintenance but was rarely performed. Prior systems where the controller (311) could not automatically engage the motor (211) in real-time were reliant on human operators to maintain the slurry and this regularly resulted in poor maintenance of the slurry. In the present embodiments, the controller (311) can assist with good maintenance by automating scheduled mixing which helps ensure that the slurry is always correctly formulated and ready for use, and that precipitation is minimized.

Once the tank (101) is empty or substantially empty of slurry, it will need to be prepared to use again. As a suspension, the slurry being withdrawn from the tank (101) will typically result in slurry residue being left in the tank (101). This will occur on the side walls due to the lowering level of the slurry as well as the lowest levels of slurry not being readily removeable. Regardless of source, the powder (325) in this residue can harden onto the inner walls of the tank (101) when the water level is decreased causing damage or its presence may result in inaccurate slurry concentrations.

In order to attempt to minimize precipitation of the powder (325) on the walls of the tank, the tank (101) may include a washing system including one or more spray heads (415). The spray head (415) may supply wash water to the tank (110) (typically from the same source as inlet (123) although a separate pump (451) and/or water inlet may be provided). Inclusion of a separate spray pump (451) can allow for water in the spray heads (415) to be discharged at a higher pressure than for the fill water through inlet (123). Spray heads (415) will not primarily serve to fill the tank (101) but will serve to spray and wash the inner surfaces of the tank (101) and may be aimed and positioned within the tank (101) to have wash water contact desired surfaces.

The additional water provided by the spray heads (415) will serve to direct slurry or precipitate which is on the walls toward the bottom of the tank (101). This will help to keep any powder in the tank (101) from solidifying on the walls. It should be noted that the sprayers (415) may also be used when the tank (101) is being filled or is full to attempt to remove suspended particles (425) from the headspace, if desired.

The washing operation will typically be automatically performed by the controller (311) when the level of slurry is sufficiently low that refilling is required and is typically performed when the tank (101) is not being filled. That is, the wash cycle is performed when both inlet water (123) and particulate (325) are not being supplied to the tank (101).

The controller (311) may also, in an embodiment, record the amount of water used in the spraying operation and that amount of water may be considered to be present in the tank (101) and the amount added in the next fill operation may be reduced by that amount, to assist in obtaining a slurry within an intended concentration range. As the amount of water (113) used in washing is recorded, the washing operation may use a relatively substantial amount of water (113) as it is not lost and is known. Such larger amounts of water (113) can result in the resulting slurry (from the particles left behind and any of the original slurry that still remained) being of very low concentration making precipitation less likely than for the target slurry. However, the mixer (111) can be engaged to further avoid precipitation of particulates from this wash slurry.

To avoid build-up in the discharge line (213), the discharge line (213) may be separately or in-combination purged with the rinsing of the tank (101). Typically, as the tank (101) is being rinsed, water may also be sent through the discharge line (213). Water for this rinse may be supplied from inside the tank (101) but, instead, will often be clean water (e.g. with no particles (325) added thereto). This may be supplied directly to the discharge line (213) bypassing the tank (101) to clean the discharge line (213) and inhibit clogging. The rinse operation of the discharge line (213) may also be performed automatically as part of a cleaning operation by the controller (311). Rinse water in the discharge line (213) may be discarded (although this results in a loss in a small amount of powder) or may be sent backwards through the discharge line (213) into the tank (101) to preserve it. In the latter operation, the amount of water used to clean the discharge line (213) may also be recorded and used in determining the amount of additional water needed to be added to the tank (101) for a future slurry formation.

In operation, a fill operation and empty operation of the tank (110) will typically proceed as follows. The system (100) will first be brought on-site to where the slurry is to be prepared, if it is not already present there. It will then be configured for slurry preparation (e.g. the tank (101) may be lowered), if necessary. The user will first prepare the system (100) for an arrival of the calcium hydroxide (hydrated lime) powder (325). The user will typically know the amount of calcium hydroxide powder (325) ordered (by weight) and their desired slurry concentration. The amount will also typically be available when the delivery arrives (typically based on the amount in the expected truckload or other source).

The user will enter these values into the controller (311) and the controller (311) will determine the amount of water (113) necessary to create a slurry with the desired concentration. The controller (311) may also determine if there is any water (113) currently in or being added to the tank (101) (e.g. because of a wash cycle), the concentration and amount of any slurry expected to still be in the tank (101), or any other value that may alter the amount of water (113) needed to make a slurry at the desired concentration.

The controller (311) will then provide the determined amount of water (113) to the tank (101). To provide the water (113), the controller (311) may commence a spraying operation using sprayers (415) as part of or before the initial water fill via the valve (123). The valve (123) will typically be used to supply the majority of the needed water (113) into the tank (101), however. The controller (311) may also engage the motor (211) to turn the mixer (111) at this time to begin agitating any slurry that may remain and to further washing due to splashing and the like of the water (113) against the tank (101) walls.

When the shipment of calcium hydroxide powder is available, the truck or other transport will be connected to the inlet (125). Presuming sufficient water (113) is present in the tank (101) (e.g. the discharge end (225) is under the water level), the truck will typically engage its onboard pneumatics and begin pumping air and powder (325) into the tank (101). As the process continues, the valve (215) will open as necessary to maintain pressure in a prespecified range. Once the powder (325) begins to flow, the controller (311) will also typically engage the dust collector (315). The fill process will continue until the powder (325) has all been transferred to the tank (101). At this stage the transport truck can be disconnected and depart.

The motor (211) will typically continue to engage the mixer (111) and agitate the slurry even after the fill operation is complete. This will help to ensure consistency and that any suspended powder (425) captured and returned by the dust collector (315) is mixed in as well. The engagement will typically continue for a fixed time to help ensure consistency in the slurry. In an embodiment, the consistency and/or level of slurry may be monitored by the controller (311) via a sensor (433) in the tank (101) to further improve consistency and/or concentration accuracy.

Once the slurry has obtained the desired level of consistency, the controller (311) will disengage the motor (211) and the mixer (111) and agitation will cease. At this time, the slurry may be dispensed by opening the drain (213) and engaging the pump (313). Again, this operation will usually be controlled via the controller (311). In this way the amount of slurry remaining in the tank (101) may be monitored (e.g. via sensor (433)) based on the amount discharged.

Should the slurry not be immediately dispensed, the slurry will be stored in the tank (101). In such a case, the controller (311) will typically engage the motor (211) and mixer (111) at predetermined intervals to agitate the slurry. As the slurry can separate over time, such periodic and automatic agitation can improve maintained consistency and allow the slurry to be dispensed at the desired consistency on demand and in real-time in the future.

Once the slurry has been substantially dispensed from the tank (101), the controller (311) may commence a spray operation by activating the sprayers (415). These also may have been activated during the fill operation, or at various times after the slurry has been formed to obtain suspended powder (425) or to wash the exposed inner surfaces of the tank (101), the mixer (111), and/or the headspace (115) or to deal with any splashing or the like of the slurry during fill and/or mixing. Typically, the amount of water used in the spraying operation will be recorded by the controller (311) so that it can be counted toward the next slurry creation and improve accuracy of the concentration. While the tank (101) is being rinsed and prepared, the discharge line (213) may also be rinsed and prepared.

If the station (100) is to be used again at the same location, the station (100) may then enter a wait mode awaiting instructions for the next slurry preparation. This wait mode may include periodic activation of the motor (211) by the controller (311) to turn the mixer (111) and prevent precipitation of the powder (325) from any wash slurry that is present in the tank (101).

If the station (100) is no longer needed on site, this wash slurry may be discharged from the tank (101). The discharge line (213) may then be purged as well. This serves to remove any remaining powder from the system (100). Once cleaned, the system (100) may be configured back into a transport mode (if that is required) and is ready to be transported to a new location.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A mobile slurry forming system, the system comprising:
a trailer, having wheels and with a tank mounted thereon, said tank including an internal mixer and a motor for operating said internal mixer;
a controller;
a valve for equalizing pressure in said tank compared to the ambient;
a dust collector;
a water inlet for supplying water to said tank;
a product inlet, for receiving a particulate from a pneumatic conveyor;
a discharge line, for discharging contents of said tank; and
a spray head, for spraying inner walls of said tank;
wherein, said controller calculates an amount of added water to add to said tank based on an amount of particulate to be provided to said tank, a desired slurry concentration, and an amount of slurry already present in said tank;
wherein, said amount of added water is supplied to said tank via said water inlet and said spray head, in combination;
wherein, said amount of particulate is provided to said tank via said product inlet; and
wherein, said controller activates said motor to engage said mixer to form a slurry in said tank.

2. The system of claim 1, wherein at least a portion of said added water is provided to said tank prior to said particulate being provided to said tank and said particulate and air from said pneumatic conveyor is injected into said tank within said portion of said added water.

3. The system of claim 1, wherein said dust collector removes suspended particulate from a headspace in said tank.

4. The system of claim 1, wherein said valve releases extra pressure generated in said tank from said pneumatic conveyor.

5. The system of claim 1, wherein said tank can move relative to said wheels.

6. The system of claim 1, wherein said controller initiates a wash cycle where said controller activates said spray head when said water inlet is not being used to supply water to said tank and said product inlet is not supplying particulate to said tank.

7. The system of claim 6, wherein said controller records an amount of wash water added to said tank during said wash cycle.

8. The system of claim 7, wherein, said wash water adds particulate suspended on said inner walls to said slurry.

9. The system of claim 1, wherein, said controller initiates a maintenance cycle where said controller activates said motor to turn said mixer when said water inlet is not being used to supply water to said tank and said product inlet is not supplying particulate to said tank.

10. The system of claim 1, wherein said particulate comprises calcium hydroxide.

11. A method of forming a slurry, the method comprising:
providing a mobile slurry system, the system comprising:
a trailer, having wheels and with a tank mounted thereon, said tank including an internal mixer and a motor for operating said internal mixer;
a dust collector; and
a spray head, for spraying inner walls of said tank;
calculating an amount of added water to add to said tank based on an amount of particulate to be provided to said tank, a desired slurry concentration, and an amount of slurry already present in said tank;
supplying said added water to said tank at partially through said spray head;
supplying said amount of particulate to said tank; and
activating said motor to engage said mixer to form a slurry in said tank.

12. The method of claim 11, wherein at least a portion of said added water is provided to said tank prior to said particulate being provided to said tank and said particulate is injected into said tank within said portion of said added water.

13. The method of claim 11, wherein said dust collector removes suspended particulate from a headspace in said tank.

14. The method of claim 11 further comprising: releasing extra pressure generated in said tank from said amount of particulate being supplied.

15. The method of claim 1 further comprising: moving said tank relative to said wheels before said tank is supplied with said added water.

16. The method of claim 11 further comprising: washing said tank by activating said spray head when said water inlet is not being used to supply water to said tank and said product inlet is not supplying particulate to said tank.

17. The method of claim 16 further comprising: recording an amount of wash water added to said tank during said washing.

18. The method of claim 17, wherein, said wash water adds particulate suspended on said inner walls to said slurry.

19. The method of claim 11, further comprising: maintaining said slurry by activating said motor to turn said mixer when said water inlet is not being used to supply water to said tank and said product inlet is not supplying particulate to said tank.

20. The method of claim 11, wherein said particulate comprises calcium hydroxide.
